(19) United States
(12) Patent Application Publication
(10) Pub. No.: US 2026/0237398 A1
(43) Pub. Date: Aug. 13, 2026

(54) SYSTEMS AND METHODS FOR AUDIO-BASED GAMES USING ARTIFICIAL INTELLIGENCE

(71) Applicant: Infobip Ltd., London (GB)

(72) Inventors: Edvin TESKEREDŽIC, Sarajevo (BA); Emanuel LACIC, Zagreb (HR); Hadžem HADŽIC, Sarajevo (BA)

(73) Assignee: Infobip Ltd., London (GB)

(21) Appl. No.: 19/049,383

(22) Filed: Feb. 10, 2025

(51) Int. Cl. G10L 25/51; A63F 13/424; G10L 15/08; G10L 15/26

(52) U.S. Cl. CPC G10L 25/51; G10L 15/08; A63F 13/424; G10L 2015/088; G10L 15/26

(57) ABSTRACT

A method may include receiving audio data representing at least one keyword from an electronic device. The method may include comparing audio data representing the at least one keyword to at least one target keyword. The method may include determining a keyword score based on the comparing of the audio data representing the at least one keyword to the at least one target keyword. The method may include generating a waveform based on the audio data. The method may include comparing the waveform to a target waveform. The method may include determining a waveform score based on the comparing of the waveform to the target waveform. The method may also include determining a total score based on the keyword score and the waveform score.

### TECHNICAL FIELD

Various embodiments of the present disclosure relate generally to systems and methods for audio-based games using artificial intelligence, and more particularly, to systems and methods for generating and operating audio-based games using artificial intelligence.

### BACKGROUND

Many companies send their employees (or representatives) to events such as conferences, networking events, or tradeshows, to help market the companies'products and/or services, and to meet individuals who may present the companies with future business opportunities (e.g., be potential leads or potential customers). However, when a company's employee interacts with a potential lead at an event, the interaction may be time-consuming, and the potential lead may not find the interaction (e.g., a discussion of the company's products and/or services) to be memorable or exciting. Moreover, the company's employee may fail to interact with other potential leads who attend the conference, thereby limiting the company's potential impact at the event.

Unless otherwise indicated herein, the materials described in this section are not prior art to the claims in this application and are not admitted to be prior art, or suggestions of the prior art, by inclusion in this section.

### SUMMARY OF THE DISCLOSURE

A method may include receiving, by a computing system, audio data representing at least one keyword from an electronic device. A method may include comparing, by the computing system, the audio data representing the at least one keyword to at least one target keyword. A method may include determining, by the computing system, a keyword score based on the comparing of the audio data representing the at least one keyword to the at least one target keyword. A method may include generating, by the computing system, a waveform based on the audio data. A method may include comparing, by the computing system, the waveform to a target waveform. A method may include determining, by the computing system, a waveform score based on the comparing of the waveform to the target waveform. A method may also include determining, by the computing system, a total score based on the keyword score and the waveform score.

A non-transitory computer readable medium may comprise one or more sequences of instructions, which, when executed by one or more processors, causes a computing system to perform operations. The operations may include receiving audio data representing at least one keyword from an electronic device. The operations may include comparing the audio data representing the at least one keyword to at least one target keyword. The operations may include determining a keyword score based on the comparing of the audio data representing the at least one keyword to the at least one target keyword. The operations may include generating a waveform based on the audio dat. The operations may include comparing the waveform to a target waveform. The operations may include determining a waveform score based on the comparing of the waveform to the target waveform. The operations may include determining a total score based on the keyword score and the waveform score.

A computing system may include a processor and a memory having programming instructions stored thereon, which, when executed by the processor, cause the computing system to perform operations. The operations may include receiving audio data representing at least one keyword from an electronic device. The operations may include comparing the audio data representing the at least one keyword to at least one target keyword. The operations may include determining a keyword score based on the comparing of the audio data representing the at least one keyword to the at least one target keyword. The operations may include generating a waveform based on the audio data. The operations may include comparing the waveform to a target waveform. The operations may include determining a waveform score based on the comparing of the waveform to the target waveform. The operations may also include determining a total score based on the keyword score and the waveform score.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts a block diagram illustrating a computing environment, according to one or more embodiments.

FIG. 1B depicts a block diagram illustrating another computing environment, according to one or more embodiments.

FIG. 2 depicts a user interface, according to one or more embodiments.

FIG. 3 depicts a user interface and associated elements, according to one or more embodiments.

FIG. 4 depicts another user interface, according to one or more embodiments.

FIG. 5 depicts information associated with a user study, according to one or more embodiments.

FIG. 6 depicts a flow diagram of a method for an audio-based game, according to one or more embodiments.

FIG. 7 depicts a flow diagram for training a machine learning model, according to one or more embodiments.

FIG. 8A is a block diagram illustrating a computing device, according to one or more embodiments.

FIG. 8B is a block diagram illustrating a computing device, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

In an exemplary use case, a person may attend an event at which booths are set up. At each booth, one or more employees of a respective company may be present and available to interact with attendees of the event. The person may approach a booth associated with Company X, where the person may begin to speak with an employee of Company X about Company X's product(s), service(s), history, value(s), and/or the like. The employee may reference a sign (or pamphlet) associated with Company X, where the sign depicts a QR code (or web address). The employee may encourage the person to play an audio-based game created by Company X by using the person's mobile device to scan the QR code (or visit the web address), where doing so may cause a display screen of the mobile device to display a web portal associated with the audio-based game. The person may follow the employee's suggestion at the event (or at a later time). It will be understood that a person (e.g., user) may be provided access to the audio-based game in any applicable manner. For example, a person may access the audio-based game at any location by accessing a link (e.g., QR code, web link, pointer, etc.) from any physical or digital location. A person may access the audio-based game from a remote location such as the user's home, work, or any other applicable location.

When the web portal is displayed on the display screen of the person's mobile device or any other user electronic device, the web portal may use a virtual agent (e.g., a machine learning-based chat bot) to prompt the person to enter the person's name, demographic information, contact information, and/or the like, in order to register to use the audio-based game. After the person enters the requested information, the virtual agent may instruct the person to record a video or voice message of the person saying a voice input such as “I love Company X” (a slogan of Company X), while modulating the volume of the person's voice such that a waveform of the person's voice matches, as closely as possible, a target waveform presented on the display of the mobile device. The target waveform may represent, for example, the shape (or profile) of a city's skyline (e.g., the skyline of the city where the event is taking place), and may be presented along with a mirror image of the shape of the city's skyline. Put differently, the target waveform may appear as an image of the shape of a city's skyline, with a mirror image of the city skyline positioned upside down, and directly below and aligned with, the shape of the city's skyline. It will be understood that the city skyline is provided as an example only, and the target waveform may correspond to any image, shape, outline, or the like. In some aspects, the target waveform may be symmetrical. The person may subsequently record a video or voice message of the person speaking the audio input, such as “I love Company X,” where the person attempted to modulate the volume of the person's voice during the speaking such that the volume corresponds to the target waveform. The virtual agent may subsequently cause the video or voice message to be processed and scored, and may then present a score to the user on the display screen of the mobile device. The virtual agent may also present a leaderboard that reflects the highest performers of the audio-based game, along with a rank of the person, on the display screen of the mobile device. The virtual agent may further encourage the person to submit an additional video or voice message of the person speaking Company X's slogan while modulating the volume of the person's voice in accordance with the target waveform, to improve the person's rank.

It will be understood that the techniques disclosed herein are not limited to the example provided above. For example, the audio-based game discussed herein may be implemented in any physical or virtual setting and is not limited to conferences, individual interactions, or companies.

Accordingly, the audio-based game, including the virtual agent, may engage the person and increase the person's interactions with the audio-based game, and further increase exposure to Company X and/or its slogan. In some aspects, Company X's name and slogan (and any other graphic(s) associated with Company X displayed on the display screen of the mobile device while the person plays the audio-based game) may be part of Company X's brand. Consequently, the Company X increases its brand exposure when the person plays the audio-based game. Further, because Company X may be able to access the person's input information (e.g., name, demographic information, contact information, etc.) that the person provided to during the registration, Company X may be able to engage with and/or follow-up with the person, who may be a potential or actual lead for Company X. Accordingly, the audio-based game may provide an entertaining, engaging, and efficient means to develop leads and build brand awareness for Company X. Further, the audio-based game may be accessible via Company X's website or other portal for other people (who may be potential leads) to engage with and play.

Accordingly, techniques disclosed herein provide an audio-based game that is implemented using audio and visual technology to encourage and/or increase engagement between a person and the audio-based game. The techniques disclosed herein provide a technical solution to presenting visual information for translation into a request for an audio input, mapping the audio output to the visual information, generating a score for that mapping, and further ranking individual scores based on the scores. Techniques disclosed herein improve gaming technology by combining visual information with audio inputs in a previously unavailable manner.

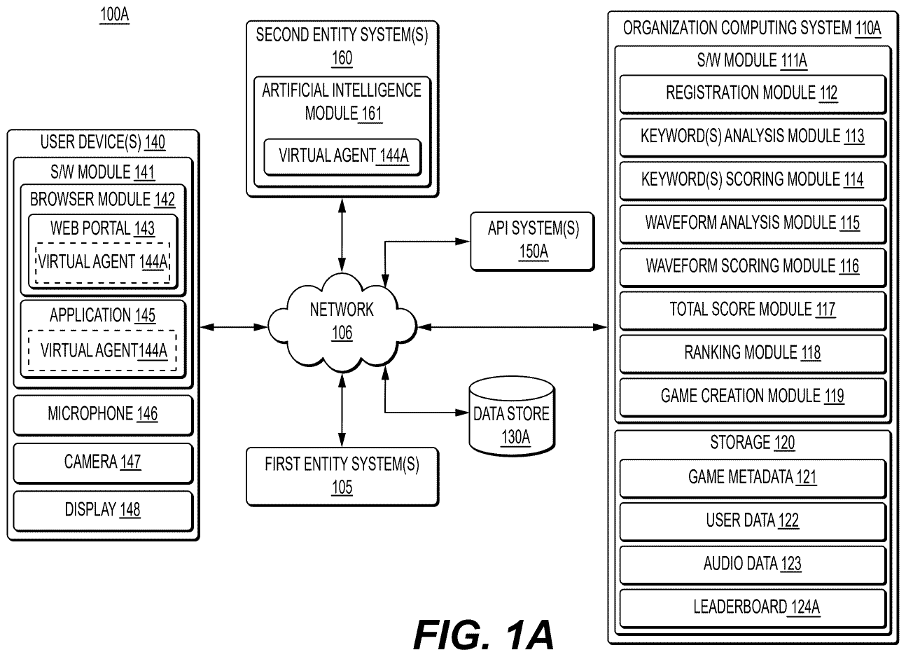

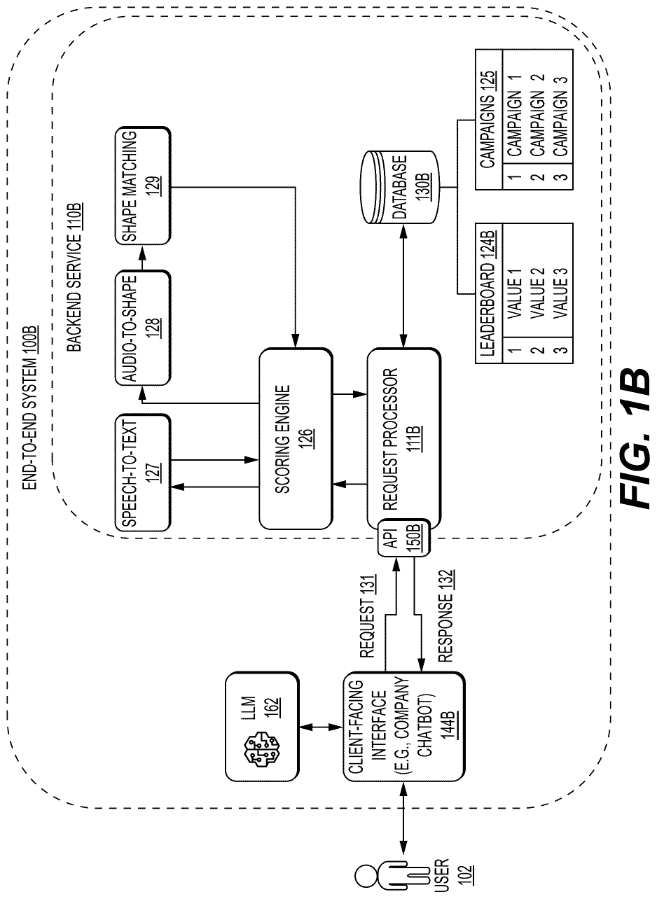

FIG. 1A is a block diagram illustrating a computing environment 100A, according to example embodiments. The computing environment 100A may include first entity system(s) 105, an organization computing system 110A, a data store 130A (e.g., a database), user device(s) 140, application programming interface (API) system(s) 150A, and second entity system(s) 160, each of the one or more components communicating via a network 106. It will be understood that although components of computing environment 100A are shown separately, one or more components may be integrated with each other (e.g., as a single component) and/or may communicate directly with each other.

The network 106 may be of any suitable type, including individual connections via the Internet, such as cellular or Wi-Fi networks. In some embodiments, the network 106 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Further, the network 106 may include any type of computer networking arrangement used to exchange data or information. For example, the network 106 may be the Internet, a private data network, virtual private network using a public network and/or other suitable connection(s) that enables components of the computing environment 100A to send and receive information between components of computing environment 100A.

The first entity system(s) 105 (also referred to herein as the “first entity system 105”) may include one or more server systems or other computing devices associated with, for example, one or more companies, people, or other entities. In some aspects, the first entity system 105 may be configured to enable an associated company (e.g., that is a client of an entity associated with the organization computing system 110A) to interact with other systems, such as the organization computing system 110A, the data store 130A, the API system(s) 150A, the user device(s) 140, and/or the second entity system(s) 160. For example, the first entity system 105 may enable a company to communicate with the organization computing system 110A to set up one or more audio-based games (e.g., voice-based competitions), which may optionally be associated with, or part of, one or more campaigns. In some embodiments, the one or more audio-based games (and/or one or more associated campaigns) may be designed or configured to collect data associated with one or more users of the user device(s) 140, where such users may represent potential business leads for (e.g., potential customers of) the company.

In some embodiments, to set up an audio-based game, the first entity system 105 may communicate with a game creation module 119 (or a wizard or software tool of the game creation module 119) of the organization computing system 110A. The first entity system 105 may be prompted by the wizard to transmit one or more pieces of information or metadata associated with the audio-based game, to the wizard. For example, the first entity system 105 may be prompted by the wizard to transmit a name (or identifier) for the audio-based game and optionally a name (or identifier) of a campaign associated with the audio-based game, to the wizard. The first entity system maybe prompted by the wizard to transmit an expiration date of the audio-based game (e.g., a date on which the audio-based game and/or associated data may deleted or disabled) and optionally an expiration date for a campaign associated with the audio-based game (e.g., a date on which the campaign or data associated with the campaign may be deleted or disabled), to the wizard. In some embodiments, the first entity system 105 may be prompted by the wizard to transmit one or more keywords (e.g., a string of one or more words), such as a name (e.g., “XYZ Company”) or a phrase (e.g., “I love XYZ Company”), associated with the audio-based game, to the wizard. As used herein, one or more keywords, or one or more phrases, transmitted from the first entity system 105 to the wizard (or the game creation module 119) may also be referred to as “one or more target keywords,” or “one or more target phrases,” respectively.

In some embodiments, the first entity system 105 may also be prompted by the wizard to transmit an image (e.g., a digital graphic or digital picture of a city's skyline or one or more objects) (also referred to herein as a “target image”) that is associated with one or more target keywords (or target phrases), to the wizard. More specifically, the first entity system 105 may be prompted by the wizard to transmit, to the wizard, an image that depicts profile(s) (e.g., outline(s) or shape(s)) of one or more objects or entities, such that where the image is binarized (e.g., converted to black and white by the organization computing system 110A), the binarized profile(s) of the one or more objects or entities exhibit one or more of (i) a degree of symmetry, (ii) perfect or total symmetry, (iii) a minimal number of gaps (e.g., regions of separation) between the one or more objects or entities, (iv) a number of gaps between the one or more objects or entities that is less than or equal to a threshold number of gaps, or (v) no gaps between the one or more objects or entities. In some embodiments, after the first entity system 105 transmits an image (e.g., of a city's skyline) to the wizard, and where the wizard determines that a binarized version of the image is insufficiently symmetric, the wizard may modify the binarized version of the image to increase the symmetry of the original binarized version of the image (e.g., by generating a mirror image of the binarized city's skyline and positioning the mirror image upside down, directly below, and aligned with, the original binarized image of the city's skyline). For example, the wizard or other applicable component may generate a symmetry value of the binarized version of the image. The wizard or other applicable component may then modify the binarized version of the image to reach a target symmetry value. Further, in some embodiments, the first entity system 105 may be prompted by the wizard to transmit one or more alternative images to the wizard, where the one or more alternative images may, when binarized by the organization computing system 110A, exhibit greater symmetry and/or fewer gaps between objects or entities, and thereby be better suited for an audio-based game. For example, the one or more alternative images may meet the target symmetry value or may be modifiable to reach the target symmetry value.

In some embodiments, the first entity system 105 may request that the wizard automatically (or dynamically) generate a target image (and binarized and/or modified binarized version of the target image) for use with the audio-based game based one or more attributes of the entity associated with the first entity system 105 (e.g., an entity profile which the first entity system 105 may transmit to the wizard). Alternatively or in addition, the first entity system 105 may request that when the audio-based game is deployed, the wizard retrieve attribute(s) of a person who plans to play or has registered to play the audio-based game (e.g., a profile for the person) and dynamically generate a target image (and binarized version of the target image) based on such attributes for use with the audio-based game. Alternatively or in addition, the first entity system 105 may request that when the audio-based game is deployed, the wizard retrieve data representing one or more current events, and dynamically generate a target image (and binarized version of the target image) based on the retrieved data for use with the audio-based game. The first entity system 105 and/or wizard may dynamically generate a target image using a machine learning model trained based on a historical or simulated dataset including current event information, images corresponding to current event information, and/or the like. The machine learning model may be trained to receive or obtain current event information and may further be trained to output an image based on inputs including such current event information.

In some embodiments, the first entity system 105 may receive an indication from the wizard that an object (or goal) of the audio-based game is for the first entity system 105 to collect, via the organization computing system 110A, data of one or more users of the user devices 140 who will play the audio-based game, where such users may represent potential leads for a company associated with the first entity system 105. The first entity system 105 may also receive an indication from the wizard that another object (or goal) of the audio-based game is for users of the user devices 140 who play the audio-based game to transmit, using the user devices 140, one or more audio recordings (or voice messages) to the organization computing system 110A such that (i) a transcription of the one or more audio recordings corresponds to (e.g., is similar or identical to) one or more target keywords (or target phrases); and (ii) an image of a waveform (or waveforms) of the one or more audio recordings corresponds to (e.g., is similar or identical to) an image of a target waveform. In some aspects, an image of a waveform of an audio recording may represent an image of an audio signal of an audio recording, where the audio signal may represent, for example, volume as a function of time, pitch as a function of time, or any other quantifiable attribute or property of the audio signal as a function of time (e.g., amplitude, frequency, wavelength, duration, timbre, bandwidth, etc.) as further described herein. An image of a target waveform may refer to an image of a shape that corresponds to or reflects (e.g., is identical or similar to) binarized profile(s) of one or more objects or entities that are symmetric (or relatively symmetric) in the image. In some embodiments, the first entity system 105 may also receive an indication from the wizard that another object (or goal) of the audio-based game is to evaluate how closely an audio recording of a user of the user device 140 matches one or more target keywords (or target key phrases) and an image of a target waveform associated with the audio-based game, and to provide the user with feedback, point(s), and/or prize(s) based on the user's performance during the audio-based game.

In some embodiments, the first entity system 105 may be prompted by the wizard to transmit one or more rules associated with the audio-based game, to the wizard. For example, the one or more rules may specify how and/or when one or more audio recordings are to be captured by the user device(s) 140 and/or transmitted to the organization computing system 110A. As another example, the one or more rules may specify that one or more tags are to be associated with data collected from one or more users of the user devices 140 who play the audio-based game, where the one or more tags may be used to identify attributes of the one or more users (or segment the users of the audio-based game). As another example, the one or more rules may specify that a QR code (or a web address) is to be generated and presented to users of the user devices 140 (e.g., when such users are attending an event, conference, or the like), so that the users can scan the QR code using camera(s) of the user devices 140 to access the audio-based game. As another example, the one or more rules may specify whether and/or how users of the user devices 140 may register to play the audio-based game, how the audio-based game is to be played by such users, and/or how the organization computing system 110A is to operate the audio-based game. For example, the one or more rules may specify how an audio recording transmitted from a user device 140 to the organization computing system 110A is to be compared to one or more target keywords (or target key phrases) and assigned a score (e.g., using techniques described herein). As another example, the one or more rules may specify how an image of a waveform representing an audio recording is to be compared to an image of a target waveform and assigned a score (e.g., using techniques described herein). As yet another example, the one or more rules may specify how a total score and/or total number of points associated with an audio recording, is to be determined (e.g., based on the comparison of the audio recording to the one or more target keywords (or target key phrases), and the comparison of the waveform associated with the audio recording to a target waveform), and using, for example, technique(s) described herein. As another example, the one or more rules may specify how many audio recordings associated with a given user of the user device 140 may be processed and/or stored using the organization computing system 110A (and optionally the data store 130A). As another example, the one or more rules may specify the content and/or format of a leaderboard to be generated, maintained, and stored for the audio-based game (e.g., to track the performances of users of the user devices 140 who play the audio-based game or only the highest performing users). As another example, the one or more rules may specify whether a portal (e.g., a webpage) is to be generated and made accessible to users of the user devices 140, where the portal may be used to reveal a winner of the audio-based game. As another example, the one or more rules may specify when and/or how one or more prizes are to be awarded to a user of the user device 140 based on the user's performance during audio-based game (e.g., where the user wins the audio-based game). As another example, the one or more rules may specify one or more statistics or metrics that may be determined based on data or audio recordings collected from users of the user devices 140. The one or more rules may also specify how the one or more statistics or metrics may be accessed by the first entity system 105 (e.g., by the first entity system 105 transmitting an identifier of an audio-based game or campaign, via the API system(s) 150A, to the organization computing system 110A, and subsequently receiving, from the organization computing system 110A and via the API system(s) 150A, one or more statistics or metrics).

Further, the wizard may prompt the first entity system 105 to transmit information (optionally as part of the one or more rules) specifying features (e.g., custom or standard features) of a virtual agent, and/or user interface associated with the virtual agent, to be generated and used with the audio-based game. As used herein, a “virtual agent” may refer to an artificial intelligence (AI)-based agent (e.g., a machine learning-based agent, a generative machine learning-based agent, a large language model (LLM)-based agent, a chatbot, a conversational agent, a software tool, or the like) configured to interact with a user of the user device 140 to facilitate the audio-based game. In some embodiments, the virtual agent may include or be associated with a user interface, as further described herein. Further, in some embodiments, a virtual agent may include one or more functions, features, or capabilities provided (or generated) by the second entity system(s) 160. In some embodiments, the first entity system 105 may specify, to the wizard, feature(s) such as particular (or types of) text, graphic(s), sound(s), and/or haptic feedback to be displayed, played, and/or provided in association with the audio-based game, using a virtual agent and the user device 140. Further, the first entity system 105 may specify, to the wizard, particular information regarding a user of the user device 140 (e.g., user data such as the user's first name, middle name, last name, employer, date of birth, phone number, email address, mailing address, demographic information, or the like), which the virtual agent is to collect from the user before the user may begin playing the audio-based game on the user device 140. The first entity system 105 may further specify, to the wizard, how a virtual agent is to explain or present the rules of an audio-based game to a user of the user device 140 (e.g., that the virtual agent is to present a textual statement to the user via a user interface presented using the user device 140, where the textual statement indicates that the user is to speak one or more keywords (or key phrases) into a microphone of the user device 140 such that the volume (pitch or other attribute) of the user's voice corresponds to a particular image of a target waveform). The first entity system 105 may also specify, to the wizard, how the virtual agent is to respond to particular input(s) provided by the user in association with the audio-based game (and/or how to respond to the user's performance during the audio-based game).

In some embodiments, the virtual agent may be included or associated with the second entity system(s) 160 and/or the API system(s) 150A. The first entity system 105 may be prompted by the wizard to provide, to the wizard, a key (e.g., a code associated with the API system(s) 150A and configured to cause, for example, the organization computing system 110A to fetch an audio recording or other data from the user device 140 via the API system(s) 150A, as part of the audio-based game).

The organization computing system 110A may include one or more server systems or other computing devices associated with, for example, an organization, company, or other entity. In some aspects, the first entity system 105 may be configured to interact with other systems of the environment 100A, such as the first entity system 105, the data store 130A, the user device(s) 140, the API system(s) 150A, and/or the second entity system(s) 160. Further, the organization computing system 110A may be configured to facilitate the generation, operation (or deployment), and/or termination of one or more audio-based games (e.g., of one or more campaigns). In some aspects, the organization computing system 110A may enable an entity associated with the first entity system 105 to create, operate, and manage (e.g., modify metadata of or access statistics or metrics associated with) one or more customized audio-based games of one or more campaigns, using the organization computing system 110A. As shown in FIG. 1A, the organization computing system 110A may include one or more of a software module 111A and a storage 120. In some aspects, the storage 120 may be an embodiment of the data store 130A.

The software module 111A may include a registration (or enrollment) module 112, a keyword(s) analysis module 113, a keyword(s) scoring module 114, a waveform analysis module 115, a waveform scoring module 116, a total score module 117, a ranking module 118, and a game creation module 119. As explained above, the game creation module 119 may be configured to communicate with, and receive information or metadata from, the first entity system 105 to generate and/or set up one or more audio-based games (e.g., associated with one or more campaigns). In some embodiments, the game creation module 119 may include a wizard or other software tool to communicate with the first entity system 105 and generate and/or set up one or more audio-based games.

In some aspects, the game creation module 119 may be configured to receive an image (e.g., a target image) from the first entity system 105. In some embodiments, upon receiving the image, the game creation module 119 may determine one or more of a symmetry score or a bijection score (e.g., a score based on bijection) for the image. In some aspects, each of the symmetry score and the bijection score may be a score (or value) between 0 and 1, wherein a higher score represents that an associated image is better suited for an audio-based game. In some embodiments, the game creation module 119 may compare one or more of the symmetry score or the bijection score to one or more threshold scores. Where the game creation module 119 determines that the symmetry score and/or the bijection score is less than one or more threshold scores, the game creation module 119 may prompt the first entity system 105 to transmit, to the game creation module 119, an alternative image that is better suited for an audio-based game.

Further, in some embodiments, where the game creation module 119 determines that an image received from the first entity system 105 depicts multiple segments of objects or entities (e.g., multiple profiles with gaps in between one another), the game creation module 119 may modify the image to include only the largest or longest segment of objects or entities (or largest or longest profile). The game creation module 119 may further incorporate the modified image in an audio-based game, and binarize and/or further process the modified image, as described further herein.

In some embodiments, the game creation module 119 may receive, from the first entity system 105, information specifying features (e.g., customized or standard features) of a virtual agent, and/or user interface associated with the virtual agent, to be used in an audio-based game. In some embodiments, the game creation module 119 may access, optionally via the API system(s) 150A, a virtual agent associated with (or stored by) the second entity system(s) 160 to modify, tailor, or customize the virtual agent in accordance with one or more feature(s) specified by the first entity system 105. The game creation module 119 may also be configured to transmit information or data associated with the audio-based game (e.g., data or metadata representing the game, image(s), keyword(s), key phrase(s), rule(s), feature(s), one or more aspects of a virtual agent, or the like) to the storage 120, for storage as game metadata 121, for example.

The registration (or enrollment) module 112 may be configured to communicate with the user device(s) 140, via the API system(s) 150A, to register (or enroll) one or more users associated with the user device(s) 140. For example, the registration module 112 may be configured to prompt a user of a user device 140 to provide user data (e.g. data representing one or more of a user's first name, middle name, last name, employer, date of birth, phone number, email address, mailing address, or the like) to the registration module 112 via a virtual agent (e.g., a virtual agent 144A) and associated user interface (e.g., displayed on a display 148) of the user device 140. In some embodiments, the registration module 112 may be configured to retrieve user data of a user associated with the user device 140 before the user is provided the ability (or permission) to play an audio-based game using the user device 140. In other embodiments, the registration module 112 may be configured to retrieve user data of a user associated with the user device 140 while the user is playing an audio-based game on the user device 140, or after the user completes the audio-based game. Further, in some aspects, the registration module 112 may be configured to transmit user data received from the user device(s) 140 to the storage 120 for storage as user data 122.

The keyword(s) (or key phrase(s)) analysis module 113 may be configured to receive one or more audio recordings (e.g., voice recordings) from the user device 140, via the API system(s) 150A, when a user of the user device 140 is playing an audio-based game (using the virtual agent 144A). In some embodiments, the keyword(s) analysis module 113 may be configured to transcribe a received audio recording, or generate a transcription (e.g., a digital transcription) of an audio recording, where the transcription represents, for example, as text, one or more words or phrases detected in the audio recording. In some embodiments, the keyword(s) analysis module 113 may be configured to use a speech-to-text model (e.g., a machine learning model, optionally associated with the second entity system(s) 160 or another entity) to extract (or generate) text from an audio recording.

Further, the keyword(s) analysis module 113 may be configured to compare the transcription of the audio recording to one or more target keywords (or target key phrases) of an audio-based game to determine the degree of dissimilarity (or similarity) between the transcription and the one or more target keywords (or target key phrases). Put differently, the keyword(s) analysis module 113 may determine difference(s) (if any) between one or more words (or phrases) of a transcription and one or more target keywords (or target key phrases) by detecting differences between sound patterns associated with the one or more words (or phrases) captured in the transcription and sound patterns associated with the one or more target keywords (or target key phrases). For example, in some embodiments, the keyword(s) analysis module 113 may determine an edit distance between one or more words (or phrases) of the transcription and the one or more target keywords (or target key phrases) of an audio-based game to determine how different (if at all) the transcription is from the one or more target keywords (or target key phrases). In some aspects, an edit distance (e.g., a Levenshtein distance) may refer to a number of changes (e.g., to letters or other characters) that need to be made to one or more words (or phrases) in order for the resulting (or changed) one or more words (or phrases) to match one or more target keywords (or target key phrases), for example. Accordingly, an edit distance of zero may represent that a transcription matches (or is identical to) one or more target keywords (or target key phrases), while an edit distance greater than zero (e.g., a positive integer) may represent the number of differences between a transcription and one or more target keywords (or target key phrases). In some aspects, the keyword(s) analysis module 113 may detect difference(s) between a transcription of an audio recording and one or more target keywords (or target key phrases) where the audio recording reflects, for example, (i) word(s) that a user of the user device 140 was not supposed to speak into a microphone 146 of the user device 140 during the audio-based game, (ii) word(s) that the user was supposed to speak into the microphone 146 during the audio-based game but mispronounced, and/or (iii) word(s) that the user correctly spoke into the microphone 146 during the audio-based game but that were distorted by ambient noise, hardware issues of the microphone 146, or the like.

The keyword(s) scoring module 114 may be configured to determine a score for an audio recording based on a comparison of the audio recording (or an associated transcription) to one or more target keywords (or target key phrases) that was performed by the keyword(s) analysis module 113. For example, the keyword(s) scoring module may determine a score for an audio recording based on an edit distance (or Levenshtein distance) calculated for the audio recording by the keyword(s) analysis module 113. In some embodiments, where the keyword(s) analysis module 113 determines that an audio recording matches or is identical to (or is within a threshold degree of being identical to) one or more target keywords (or target key phrases) (e.g., where an associated edit distance or Levenshtein distance is equal to or near zero), the keyword(s) scoring module 114 may assign a full score (e.g., a maximum score or a score of 1) to the audio recording. Where the keyword(s) analysis module 113 determines that an audio recording partially matches one or more target keywords (or target key phrases) (e.g., where an associated edit distance or Levenshtein distance is an integer greater than zero but less than a maximum or threshold distance), the keyword(s) scoring module 114 may assign a score that is proportional to the degree of matching (e.g., a score greater than zero but less than 1), to the audio recording. Where the keyword(s) analysis module 113 determines that an audio recording does not at all match one or more target keywords (or target key phrases) (e.g., where an associated edit distance or Levenshtein distance is greater than or equal to a maximum or threshold distance), the keyword(s) scoring module 114 may assign a minimum score (e.g., a score of 0) to the audio recording. As used herein, a score that is determined by the keyword(s) scoring module 114 may also be referred to as a “keyword score,” “keywords score,” “key phrase score,” or “key phrases score.”

The waveform analysis module 115 may be configured to receive one or more audio recordings (e.g., voice recordings) from the user device 140, via the API system(s) 150A, when a user of the user device 140 is playing an audio-based game (using the virtual agent 144A). In some embodiments, the waveform analysis module 115 may be configured to process a received audio recording prior to comparing the received audio recording to an image of a target waveform associated with an audio-based game. For example, upon receiving an audio recording, the waveform analysis module 115 may trim (or remove) one or more (or all) periods of silence detected in the audio recording by removing samples of audio values (e.g., representing volume) that are below a pre-defined threshold value. The waveform analysis module 115 may further generate an image of a waveform representing the audio recording (but not the one or more periods of silence). In some aspects, the waveform represented in the image may represent volume (or another quantifiable characteristic of an audio recording, such as pitch, tone, or emotions or traits such as happy, sad, playful, funny, or angry) as a function of time. In some embodiments, the waveform analysis module 115 may use media blurring to blur the image of the waveform in order to smooth any rough edges of the waveform. Such smoothing may increase the likelihood that the image of the waveform is subsequently determined to match an image of a target waveform (or make waveform-matching more tolerant). As explained above, in some embodiments, where an image of a target waveform includes multiple segments of the target waveform, the game creation module 119 may modify the image to include only the largest segment of the target waveform (e.g., for comparison to an image of a waveform based on an audio recording).

In some embodiments, after generating and processing the image of the waveform based on the audio recording, the waveform analysis module 115 may scale one or more of the image of the waveform and an image of a target waveform, such that these two images have the same dimensions. The waveform analysis module 115 may further compare, for example, the scaled image of the waveform to the scaled image of the target waveform by performing a similarity calculation based on the two scaled images. For example, the waveform analysis module 115 may calculate an intersection-over-union (IOU) of the two scaled images. In some aspects, an IOU may represent a ratio of (i) area(s) of intersection of two images over (ii) area(s) of union of the two images. An area of intersection may refer to an area of the scaled image representing the waveform that overlaps with the scaled image representing the target waveform. An area of union may represent a total area of one of the scaled images, less the area of intersection. The higher the value of an IOU, the more closely the scaled image of the waveform matches the scaled image of the target waveform.

The waveform scoring module 116 may be configured to determine a score (also referred to herein as a “waveform score”) for a scaled image of a waveform based on a comparison of the scaled image of the waveform to a scaled image of a target waveform performed by the waveform analysis module 115. For example, the waveform scoring module 116 may determine a waveform score for a scaled image of waveform by applying a sigmoid function (e.g., a logistic function) to an IOU determined for the scaled image of the waveform by the waveform analysis module 115. In some aspects, the resulting waveform score may have a value between 0 and 1.

The total score module 117 may be configured to determine a total score for an audio recording based on a keyword score and a waveform score. In some embodiments, the total score module 117 may determine a total score for an audio recording by taking an average of a keyword score and a waveform score, and optionally multiplying the resulting average by 1000. In some embodiments, a total score may range from 0 to 1000. Further, in some embodiments, the total score module 117 may be configured to transmit a total score for an audio recording to the user device 140 (via the API system(s) 150A), for display on a display 148.

The ranking module 118 may be configured to determine a rank of a user associated with the user device 140 based on an audio recording associated with the user. For example, the ranking module 118 may compare a total score for the audio recording associated with the user to one or more total scores of the leaderboard 124A to determine a rank for the user. In some aspects, the rank may represent a position of the user on the leaderboard 124A. In some embodiments, the ranking module 118 may transmit the rank to the user device 140 (via the API system(s) 150A) for display on the display 148. Further, in some embodiments, the virtual agent 144A may display on the display 148, for example, how much a total score of a user needs to improve in order for the user to move up to the next position (or higher rank) of the leaderboard 124A. Further, the ranking module 118 may transmit the rank to the storage 120 for storage within, for example, the leaderboard 124A.

In some embodiments, where the organization computing system 110A receives multiple audio recordings associated with a user of the user device 140, and where the total score module 117 determines a respective total score for each of the multiple audio recordings, the total score module 117 may transmit only the highest total score to the storage 120 for storage. Further, in some aspects, the organization computing system 110A may be configured to store one or more audio recordings received from the user device 140 in the storage 120 as audio data 123, for example.

The user device(s) 140 (also referred to herein as a “user device 140” or “user devices 140”) may be configured to enable an associated user to (i) access and/or interact with other systems in the environment 100A and/or (ii) play an audio-based game. In some aspects, the user device 140 may be a computer system such as, for example, a mobile device, a tablet, a laptop, a desktop computer, etc. As shown in FIG. 1A, the user device 140 may include a software (S/W) module 141, a microphone 146, a camera 147, and/or a display 148.

The S/W module 141 may include one or more of a browser module 142 and an application 145. The browser module 142 may be configured to receive data representing one or more webpages, websites, or web portals from the network 106. For example, the browser module 142 may receive a web portal 143 from the second entity system(s) 160 (via the network 106) for display on the display 148. In some embodiments, the web portal 143 may represent a messaging platform and/or user interface in which the virtual agent 144A is integrated, where the web portal 143 and/or the virtual agent 144A may enable a user of the user device 140 to play an audio-based game. The application 145 may be a program, plugin, browser extension, add on, etc., installed on a memory of the user device 140. In some embodiments, the application 145 may represent a messaging platform and/or user interface in which the virtual agent 144A is integrated, where the application 145 and/or the virtual agent 144A may enable a user of the user device 140 to play an audio-based game.

The microphone 146 may represent a sensor configured to detect sound waves (e.g., of a voice of a user associated with the user device 140). In some embodiments, the microphone 146 may be configured to communicate with the virtual agent 144A to capture an audio recording (e.g., of a user's voice) associated with an audio-based game. In some embodiments, the microphone 146 and/or the virtual agent 144A may be configured transmit the audio recording to the organization computing system 110A (via the API system(s) 150A) for processing and evaluation as part of the audio-based game.

The camera 147 may represent an optical sensor configured to image (e.g., take a photo of or scan of) one or more objects in a field of view of the camera 147. In some embodiments, the camera 147 may be used to image a QR code associated with an audio-based game, such that web portal 143 or the application 145 is subsequently launched on the user device 140. Further, in some embodiments, the camera 147 may be configured to operate with the microphone 146 to record a video (e.g., a video of a user of the user device 140 speaking while playing an audio-based game).

The display 148 may represent a display screen included in or associated with the user device 140. In some embodiments, the display 148 may be configured to display one or more user interfaces of (i) the web portal 143 and (ii) the application 145.

The API system(s) 150A (also referred to herein as an “API system 150A”) may include a server or other computing device, and may be configured to interact with, and facilitate communication between, other systems in the environment 100A, such as the organization computing system 110A, the data store 130A, the first entity system 105, the second entity system 160, and/or the user device 140. In some embodiments, the API system 150A may be configured to receive and respond to a request for information or the like. Further, in some embodiments, the API system 150A may include (or be configured to generate) an API that represents a standard API or a customized (or tailored) API. For example, the API system 150A may include an API that is customized (or configured) to facilitate an audio-based game (including a virtual agent of the audio-based game).

The second entity system(s) 160 (also referred to herein as a “second entity system 160”) may include one or more server systems or other computing devices associated with one or more companies, people, or other entities. In some aspects, the second entity system 160 may be configured to enable a company to interact with other systems of the environment 100A, such as the organization computing system 110A, the data store 130A, the API system(s) 150A, and/or the user device(s) 140. In some embodiments, the second entity system 160 may provide a messaging platform that may be delivered to the user device 140 as, for example, a website, a webpage, a web portal (e.g., the web portal 143), an application (e.g., the application 145), or the like. In some aspects, the second entity system 160 may generate or support an API associated with or included in the API system 150A, where the API facilitates an audio-based game.

Further, as shown in FIG. 1A, the second entity system 160 may include an artificial intelligence module 161. In some embodiments, the artificial intelligence module 161 may be configured to generate and optionally store a virtual agent that represents a standard virtual agent or a customized (or tailored) virtual agent (e.g., the virtual agent 144A), configured to facilitate an audio-based game. In some embodiments, the artificial intelligence module 161 may be configured to support the generation of a virtual agent (e.g., the virtual agent 144A) by the API system 150A and/or the organization computing system 110A, for example.

FIG. 1B depicts a block diagram illustrating a computing environment 100B (also referred to herein as an “end-to-end system 100B”), according to example embodiments. In some aspects, the end-to-end system 100B may be an embodiment of the computing environment 100A of FIG. 1A. Further, the end-to-end system 100B may be configured to facilitate the generation (or creation), operation (or deployment or maintenance), and/or termination of one or more audio-based games (e.g., of one or more campaigns).

In some embodiments, a user 102 may use a display screen of a user device (e.g., the display 148 of the user device 140) to view and interact with a client-facing interface 144B. The client-facing interface 144B may represent or include a company chatbot, and be an embodiment of the virtual agent 144A. The client-facing interface 144B may also be referred to herein as a “virtual agent 144B.” In some aspects, the client-facing interface 144B may be configured to communicate with, and/or be supported by, a large language model (LLM) 162 (e.g., of the second entity system(s) 160 or the artificial intelligence module 161). Further, the client-facing interface 144B may be configured to receive and respond to inputs provided by the user 102 in association with one or more audio based-games. For example, after the user 102 has registered to play an audio-based game, and after the client-facing interface 144B has instructed the user 102 how to play the audio-based game, the client-facing interface 144B may receive from the user 102, and via a microphone of the user device, an audio recording in which the user 102 stated a slogan (e.g., a phrase) while modulating the volume of the user 102's voice such that a waveform of the user 102's voice matches, as closely as possible, a target waveform presented on the display of the user device. In some embodiments, the client-facing interface 144B may be configured to send the audio recording (also referred to as a “request 131” in FIG. 1B) to a backend service 110B for processing and evaluation. More specifically, the client-facing interface 144B may cause the audio recording to be transmitted to the backend service 110B via an API 150B. In some embodiments, the API 150B may be an embodiment of the API 150A.

The backend service 110B may represent one or more services, software components and/or hardware components configured to generate, operate (or maintain or deploy), and/or terminate the audio-based game. In some aspects, the backend service 110B may be an embodiment of the organization computing system 110A. As shown in FIG. 1B, the backend service 110B may include a request processor 111B, a scoring engine 126, and a database 130B, optionally among other components. Further, in some embodiments, the backend service 110B may include the API 150B.

The request processor 111B may be configured to receive the audio recording (or request 131 or other communication) from the client-facing interface 144B via the API 150B. The request processor 111B may be an embodiment of the S/W module 111A. In some embodiments, the request processor 111B may be configured to transmit the audio recording to the scoring engine 126. The scoring engine 126 may be configured to determine a keyword score, a waveform score, and a total score, for the audio recording. As shown in FIG. 1B, the scoring engine 126 may be configured to have the audio recording transcribed during a speech-to-text 127 operation (e.g., performed by the keyword(s) analysis module 113). The scoring engine 126 may further be configured to receive the transcription resulting from the speech-to-text 127 operation, compare the transcription to a target phrase, and determine a keyword score based on the comparison (e.g., using techniques described herein). The scoring engine 126 may also be configured to have the audio recording converted to an image of a waveform at the audio-to-shape 128 operation (e.g., performed using the waveform analysis module 115), and to have the image of the waveform compared to a target waveform at the shape matching 129 operation (e.g., performed using the waveform analysis module 115). The scoring engine may also receive the information representing the comparison (as shown in FIG. 1B) and determine a waveform score based on the information representing the comparison. The scoring engine 126 may determine a total score for the audio recording based on the keyword score and the waveform score (e.g., using techniques described herein). The scoring engine 126 may further transmit the total score to the request processor 111B.

In some embodiments, the request processor 111B may transmit, via the API 150B, the total score to the client-facing interface 144B (e.g., as a response 132) so the user 102 can view the total score. The request processor 111B may also retrieve, from the database 130B, a leaderboard 124B, and transmit the leaderboard 124B, via the API 150B, to the client-facing interface 144B, so the user 102 can view the leaderboard 124B. In some embodiments, the leaderboard 124B may be an embodiment of the leaderboard 124A. Further, the database 130B may be an embodiment of the data store 130A and/or the storage 120. As shown in FIG. 1B, the database 130B may store, in addition to the leaderboard 124B, campaigns 125.

It is noted that the end-to-end system 100B is an example. The end-to-end system 100B may contain more or fewer functionalities or components than those described herein. Further, it will be understood that although components of computing environment 100B are shown separately, one or more components may be integrated with each other (e.g., as a single component) and/or may communicate directly with each other.

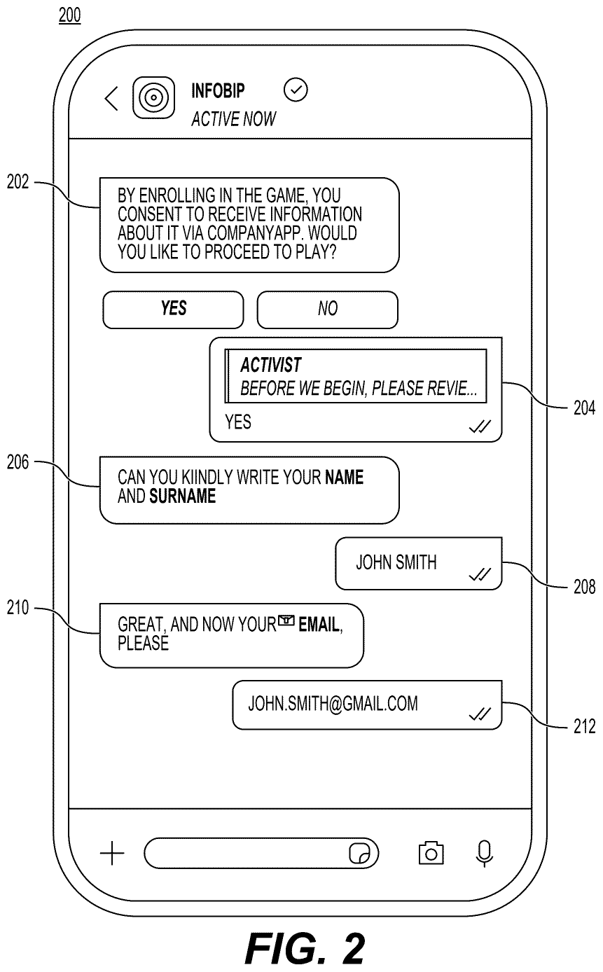

FIG. 2 depicts a user interface, according to one or more embodiments. More specifically, FIG. 2 depicts a user interface 200 that may be displayed on a display screen associated with a user device (e.g., the user device 140), when a user of the user device is interacting with a virtual agent (e.g., the virtual agent 144A or 144B) to enroll in an audio-based game. In some embodiments, the virtual agent may communicate with a registration module (e.g., the registration module 112) during the enrollment. As shown in FIG. 2, at a box 202, the virtual agent may ask the user to consent to receive information (e.g., from the API system 150A, the second entity system 160, the organization computing system 110A, or another system of the environment 100A or the environment 100B). The virtual agent may prompt the user to answer the question by presenting the user with a button that indicates “YES,” and a button that indicates “NO.” At box 204, the user may review and/or consent to (or decline) a policy associated with the audio-based game. At box 206, the virtual agent may ask the user to provide the user's name and surname. At box 208, the user may enter the user's name and surname. At box 210, the virtual agent may prompt the user to enter the user's email address, and at box 212, the user may enter the user's mail address. It is noted that the user interface 200 is merely an example.

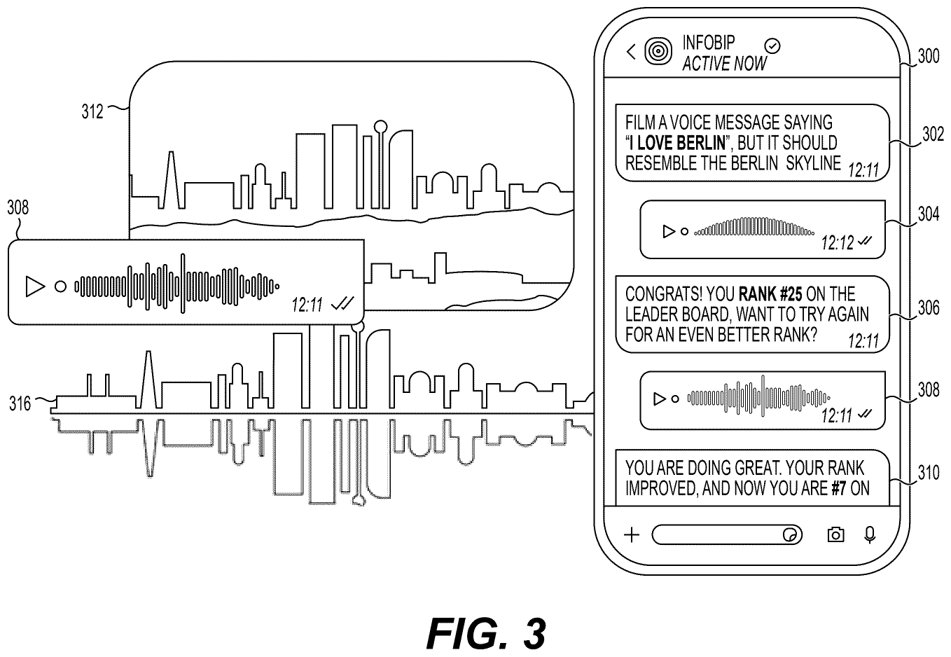

FIG. 3 depicts a user interface and associated elements, according to one or more embodiments. More specifically, FIG. 3 depicts a user interface 300 (e.g., a display) that may be displayed on a display screen associated with a user device (e.g., the user device 140), when a user of the user device is interacting with a virtual agent (e.g., the virtual agent 144A or 144B) to play an audio-based game. In some embodiments, the virtual agent may communicate with the organization computing system 110A (e.g., the keyword(s) analysis module 113, the keyword(s) scoring module 114, the waveform analysis module 115, the waveform scoring module 116, the total score module 117, the ranking module 118, and/or the storage 120). As shown in FIG. 3, at box 302, the virtual agent may instruct the user how to play the audio-based game (e.g., by “[f]ilming [or recording] a voice message saying ‘I love Berlin’, but it should resemble the Berlin skyline.”). In some aspects, an image of the Berlin skyline (312) and a binarized and symmetric image of the Berlin skyline (316) may also be displayed in the user interface 300. The user may subsequently record a video or voice message of the user speaking, “I love Berlin,” using the user device. In some embodiments, the user device may be configured to subsequently generate and display an image of a waveform of the recording (along with a play button, which the user may select to play the recording, if the user desires) on the display 300 at box 304. Alternatively, once the user records a video or voice message of the user speaking, “I love Berlin,” the virtual agent may transmit the recording to the organization computing system 110A for processing and scoring, and the virtual agent may subsequently receive from the organization computing system 110A, an image of a waveform of the recording, along with a play button, which the user may select in order to play the recording, if the user desires. At box 306, the virtual agent may provide a response to the user based on the user's performance (e.g., an expression of congratulations, the user's rank, and an invitation to play the audio-based game again). If the user elects to play the audio-based game again (or submit a second video or voice message), the display 300 may subsequently present an image of the waveform corresponding to the second recording along with a play button (in a manner similar to that described above), at box 308. The virtual agent may provide a response and updated rank at box 310.

It is noted that the user interface 300 is merely an example. Further, in some embodiments, the user interface 300 may present an image of a waveform (e.g., a semi-transparent image of a waveform) of a user's recording overlaid on an image of a binarized target waveform (e.g., 316) so that the user can see how the user's performance compares to an ideal (or perfect) performance.

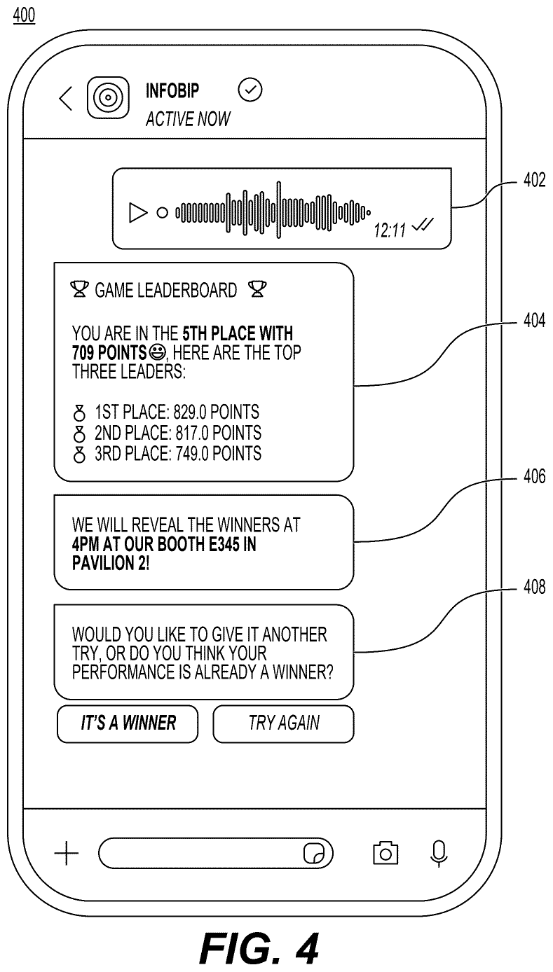

FIG. 4 depicts a user interface, according to one or more embodiments. More specifically, FIG. 4 depicts a user interface 400 that may be displayed on a display screen associated with a user device (e.g., the user device 140), after a user of the user device has played an audio-based game. As shown in FIG. 4, an image of a waveform corresponding to an audio recording submitted by the user may be presented, along with a play button (which the user may select if the user wishes to listen to the audio recording), in the user interface 400 at box 402. At box 404, a virtual agent (e.g., the virtual agent 144A) may present the user with a leaderboard (e.g., the leaderboard 124A), along with the user's ranking based on the user's audio recording at box 402. The virtual agent may further indicate when and where (e.g., a location at a conference or other event) winner(s) of the audio-based game will be announced, at box 406. The virtual agent may further ask the user if the user would like to play the audio-based game again, at box 408. The user may respond by selecting, for example, a button indicating “It's a win” or a button indicating “Try again,” as shown in the user interface 400. It is noted that the user interface 400 is merely an example. Further, in some embodiments, one or more of the user interface 200, 300, or 400 may represent a user interface of a messaging platform (e.g., associated with the second entity system 160).

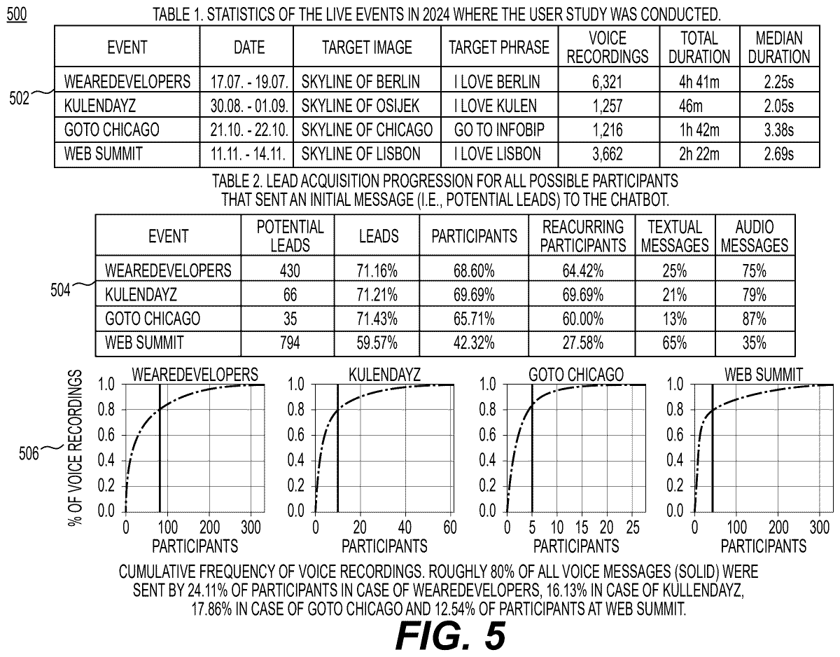

FIG. 5 depicts information 500 associated with a user study, according to one or more embodiments. To validate the efficacy of systems and methods for audio-based games (or competitions) discussed herein, a user study was conducted across two larger live events (i.e., WeAreDevelopers and Web Summit) and two smaller live events (i.e., Kullendayz and GOTO Chicago). The aim of the study was to answer the question of how effective a gamified voice competition is in engaging users, acquiring leads, and sustaining their participation. As seen in Table 1 (502), each competition incorporated unique target phrases aligned with the event theme as well as the skyline of the respective city of the event as the target image (also shown in FIG. 3). The duration of the audio messages between all events ranged from 0.5 to 16.8 seconds. In addition to that, the larger events did attract more engagement with respect to the number of voice recordings and total time of all recorded voice messages.

The overall performance of each voice-based competition is reported in Table 2 (504). To be noted here, the reported proportion of audio messages reflect the number of voice recordings shown in Table 1 (502). Overall, the participation rate once a user has sent an initial message is high (e.g., a potential lead becomes a lead once the user registration for the competition is finished, and becomes a participant if at least one voice recording has been sent). The progression from potential leads to recurring participants highlights the differences in user engagement across events. The two smaller events demonstrated strong transition probabilities. In contrast, the two larger events exhibited more varied outcomes. While WeAreDevelopers maintained also a high level of recurring participation, Web Summit showed a notable drop-off. That is, at Web Summit there was a much higher proportion of textual messages when compared to voice recordings. The reason for such a behavior may lie in the chatbot flow that was additionally extended for Web Summit-a Retrieval-Augmented Generation (RAG) component that invited participants of the conference (i.e., without the need of completing a registration) to find out additional information about Infobip's services. Although, still fulfilling the purpose of brand awareness, such an addition may have inadvertently directed participants away from the competition and reduced the prominence of audio-based engagement. With respect to individual user engagement, as shown in FIG. 5 at 506, a small subset of highly active participants contributed the most to the total number of recorded voice messages. This almost matches with the Pareto Principle as the distribution of recorded voice messages does have characteristics of a power-law distribution. For example, the most active participant at WeAreDevelopers recorded 460 voice messages, at KulenDayz it was 259, for GOTO Chicago 381 and 298 at Web Summit. Overall, the findings suggest that voice-based competitions can resonate strongly within conversational agents at live events.

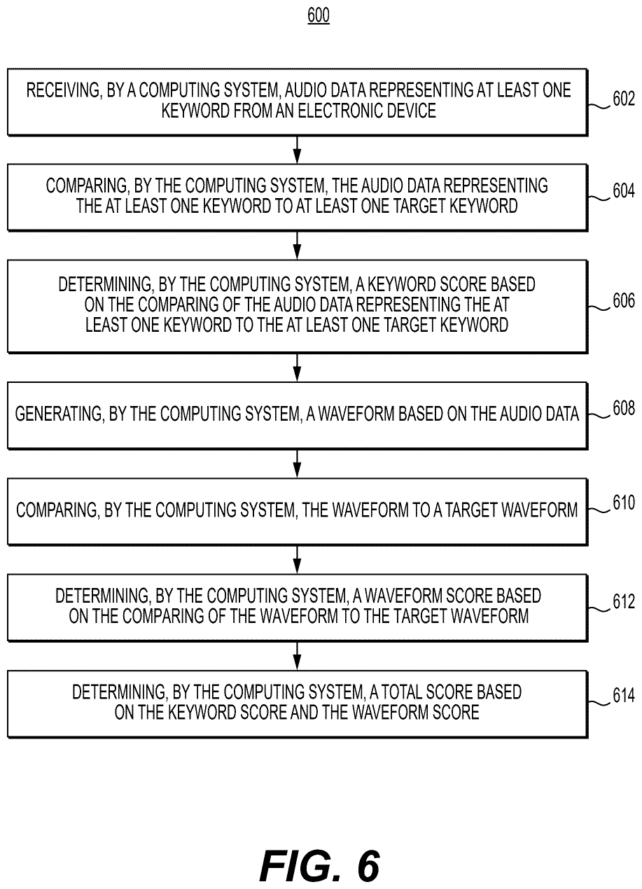

FIG. 6 depicts a flow diagram of a method 600 for an audio-based game, according to one or more embodiments. In some embodiments, the method 600 may be performed by the organization computing system 110A and/or using the backend service 110B.

As shown in FIG. 6, the method 600 may include receiving, by a computing system (e.g., the organization computing system 110A), audio data (e.g., an audio recording or audio data of a recorded video) representing at least one keyword from an electronic device (e.g., the user device 140, a company device, a device with a microphone, or the like) (602). In some embodiments, the method 600 may further include receiving, by the computing system, user data associated with a user of the electronic device, where the audio data is associated with the user. The method 600 may also include storing, by the computing system, the user data (e.g., as the user data 122).

The method 600 may include comparing, by the computing system, the audio data representing the at least one keyword to at least one target keyword (604). In some embodiments, step 604 of the method 600 may include (i) providing, by the computing system, the audio data to a speech-to-text machine learning model, where the speech-to-text machine learning model is trained to generate a transcription of the at least one keyword based on the audio data; (ii) receiving, from the speech-to-text machine learning model, the transcription of the at least one keyword based on the audio data; and optionally (iii) determining, by the computing system, an edit distance between the transcription of the at least one keyword and the target keyword. The method 600 may further include determining, by the computing system, a keyword score based on the comparing of the audio data representing the at least one keyword to the at least one target keyword (606).

The method 600 may include generating, by the computing system, a waveform (e.g., an image of a waveform, such as the image at box 304 of FIG. 3) based on the audio data (608). In some embodiments, the waveform may represent (or depict) a change in an audio property (e.g., volume, pitch, or the like) of the audio data over time. The method 600 may include comparing, by the computing system, the waveform to a target waveform (e.g., an image of a target waveform, such as the image at 316 of FIG. 3) (610). In some embodiments, the comparison of step 610 may include determining, by the computing system, an intersection-over-union based on the waveform and the target waveform.

The method 600 may include determining, by the computing system, a waveform score based on the comparing of the waveform to the target waveform (612). The method 600 may include determining, by the computing system, a total score based on the keyword score and the waveform score (614). In some embodiments, the total score may be determined by applying, by the computing system, a sigmoid function to the intersection-over-union. Further, in some embodiments, the method 600 may include transmitting, by the computing system, the total score to a machine learning-based chat bot of the electronic device via an application programming interface (e.g., an API of the API system(s) 150A, or the API 150B). In some embodiments, the method 600 may include (i) comparing, by the computing system, the total score to a plurality of scores (e.g., in the leaderboard 124A or 124B), and (ii) determining, by the computing system, a rank of the total score based on the comparing of the total score to the plurality of scores, the rank being associated with a user of the electronic device. In some embodiments, the method 600 may include, prior to the step 602, receiving, by the computing system, metadata including at least the target keyword and an image associated with the target waveform (e.g., in order to create or set up the audio-based game).

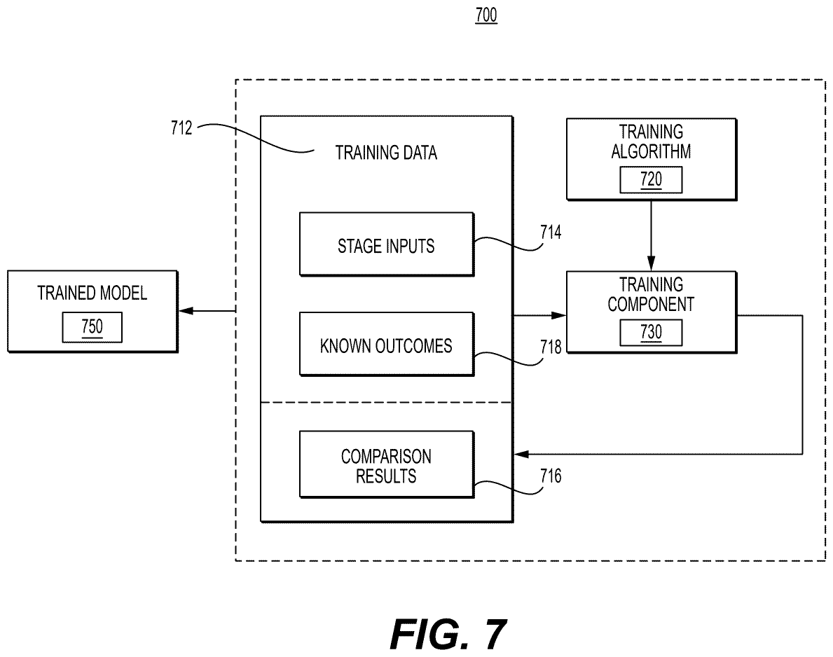

FIG. 7 depicts a flow diagram for training a machine learning model, in accordance with an aspect of the disclosed subject matter. As shown in flow diagram 700 of FIG. 7, training data 712 may include one or more of stage inputs 714 and known outcomes 718 related to a machine learning model to be trained. The stage inputs 714 may be from any applicable source including a component or set shown in the figures provided herein. The known outcomes 718 may be included for machine learning models generated based on supervised or semi-supervised training. An unsupervised machine learning model might not be trained using known outcomes 718. Known outcomes 718 may include known or desired outputs for future inputs similar to or in the same category as stage inputs 714 that do not have corresponding known outputs.

The training data 712 and a training algorithm 720 may be provided to a training component 730 that may apply the training data 712 to the training algorithm 720 to generate a trained machine learning model 750. According to an implementation, the training component 730 may be provided comparison results 716 that compare a previous output of the corresponding machine learning model to apply the previous result to re-train the machine learning model. The comparison results 716 may be used by the training component 730 to update the corresponding machine learning model. The training algorithm 720 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 700 may be a trained machine learning model 750.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

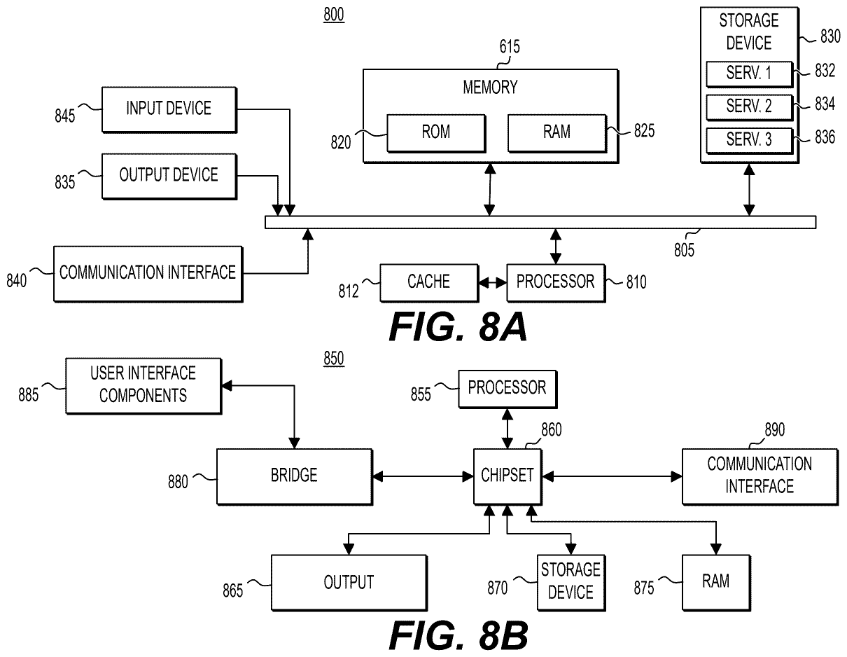

FIG. 8A illustrates an architecture of computing system 800, according to example embodiments. System 800 may be representative of at least a portion of organization computing system 110A or another system or device of the environment 100A or the environment 100B. One or more components of system 800 may be in electrical communication with each other using a bus 805. System 800 may include a processing unit (CPU or processor) 810 and a system bus 805 that couples various system components including the system memory 815, such as read only memory (ROM) 820 and random access memory (RAM) 825, to processor 810. System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing system 800, an input device 845 may represent any number of input mechanisms, such as a microphone for speech, a touch-sensitive screen for gesture or graphical input, keyboard, mouse, motion input, speech and so forth. An output device 835 (e.g., display) may also be one or more of a number of output mechanisms known to those of skill in the art. In some instances, multimodal systems may enable a user to provide multiple types of input to communicate with computing system 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, output device 835, and so forth, to carry out the function.

FIG. 8B illustrates a computer system 850 having a chipset architecture that may represent at least a portion of organization computing system 110A or another system or device of the environment 100A. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855. In this example, chipset 860 outputs information to output 865, such as a display, and may read and write information to storage device 870, which may include magnetic media, and solid-state media, for example. Chipset 860 may also read data from and write data to RAM 875. A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage device 870 or RAM 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
receiving, by a computing system, audio data representing at least one keyword from an electronic device;
comparing, by the computing system, the audio data representing the at least one keyword to at least one target keyword;
determining, by the computing system, a keyword score based on the comparing of the audio data representing the at least one keyword to the at least one target keyword;
generating, by the computing system, a waveform based on the audio data;
comparing, by the computing system, the waveform to a target waveform;
determining, by the computing system, a waveform score based on the comparing of the waveform to the target waveform; and
determining, by the computing system, a total score based on the keyword score and the waveform score.

2. The method of claim 1, wherein comparing, by the computing system, the audio data representing the at least one keyword to the at least one target keyword comprises:
providing, by the computing system, the audio data to a speech-to-text machine learning model, wherein the speech-to-text machine learning model is trained to generate a transcription of the at least one keyword based on the audio data; and
receiving, from the speech-to-text machine learning model, the transcription of the at least one keyword based on the audio data.

3. The method of claim 2, wherein comparing, by the computing system, the audio data representing the at least one keyword to the at least one target keyword further comprises:
determining, by the computing system, an edit distance between the transcription of the at least one keyword and the at least one target keyword.

4. The method of claim 1, wherein the waveform represents a change in an audio property of the audio data over time.

5. The method of claim 1, wherein comparing, by the computing system, the waveform to the target waveform comprises:
determining, by the computing system, an intersection-over-union based on the waveform and the target waveform.

6. The method of claim 1, wherein determining, by the computing system, the total score based on the keyword score and the waveform score comprises:
applying, by the computing system, a sigmoid function to an intersection-over-union.

7. The method of claim 1, further comprising:
transmitting, by the computing system, the total score to a machine learning-based chat bot of the electronic device via an application programming interface.

8. The method of claim 1, further comprising:
receiving, by the computing system, user data associated with a user of the electronic device, wherein the audio data is associated with the user; and
storing, by the computing system, the user data.

9. The method of claim 1, further comprising:
receiving, by the computing system, metadata including at least the target keyword and an image associated with the target waveform.

10. The method of claim 1, further comprising:
comparing, by the computing system, the total score to a plurality of scores; and
determining, by the computing system, a rank of the total score based on the comparing of the total score to the plurality of scores, the rank being associated with a user of the electronic device.

11. A non-transitory computer readable medium comprising one or more sequences of instructions, which, when executed by one or more processors, causes a computing system to perform operations comprising:
receiving audio data representing at least one keyword from an electronic device;
comparing the audio data representing the at least one keyword to at least one target keyword;
determining a keyword score based on the comparing of the audio data representing the at least one keyword to the at least one target keyword;
generating a waveform based on the audio data;
comparing the waveform to a target waveform;
determining a waveform score based on the comparing of the waveform to the target waveform; and
determining a total score based on the keyword score and the waveform score.

12. The non-transitory computer readable medium of claim 11, wherein comparing the audio data representing the at least one keyword to the at least one target keyword comprises:
providing the audio data to a speech-to-text machine learning model, wherein the speech-to-text machine learning model is trained to generate a transcription of the at least one keyword based on the audio data; and
receiving, from the speech-to-text machine learning model, the transcription of the at least one keyword based on the audio data.

13. The non-transitory computer readable medium of claim 12, wherein comparing the audio data representing the at least one keyword to the at least one target keyword further comprises:
determining an edit distance between the transcription of the at least one keyword and the at least one target keyword.

14. The non-transitory computer readable medium of claim 11, wherein the waveform represents a change in an audio property of the audio data over time.

15. The non-transitory computer readable medium of claim 11, wherein comparing the waveform to the target waveform comprises:
determining an intersection-over-union based on the waveform and the target waveform.

16. The non-transitory computer readable medium of claim 11, wherein determining the total score based on the keyword score and the waveform score comprises:
applying a sigmoid function to an intersection-over-union.

17. The non-transitory computer readable medium of claim 11, wherein the operations further comprise:
transmitting the total score to a machine learning-based chat bot of the electronic device via an application programming interface.

18. The non-transitory computer readable medium of claim 11, wherein the operations further comprise:
receiving user data associated with a user of the electronic device, wherein the audio data is associated with the user; and
storing the user data.

19. A computing system, comprising:
a processor; and
a memory having programming instructions stored thereon, which, when executed by the processor, cause the computing system to perform operations comprising:
receiving audio data representing at least one keyword from an electronic device;
comparing the audio data representing the at least one keyword to at least one target keyword;
determining a keyword score based on the comparing of the audio data representing the at least one keyword to the at least one target keyword;
generating a waveform based on the audio data;
comparing the waveform to a target waveform;
determining a waveform score based on the comparing of the waveform to the target waveform; and
determining a total score based on the keyword score and the waveform score.

20. The computing system of claim 19, wherein comparing the audio data representing the at least one keyword to the at least one target keyword comprises:
providing the audio data to a speech-to-text machine learning model, wherein the speech-to-text machine learning model is trained to generate a transcription of the at least one keyword based on the audio data; and
receiving, from the speech-to-text machine learning model, the transcription of the at least one keyword based on the audio data.
